(19) United States
(12) Patent Application Publication
(10) Pub. No.: US 2008/0059746 A1
(43) Pub. Date: Mar. 6, 2008

(54) Distributed storage network

(76) Inventor: Michael Fisher, WESTERFIELD ROAD (GB)

Correspondence Address: NIXON & VANDERHYE, PC, 901 NORTH GLEBE ROAD, 11TH FLOOR, ARLINGTON, VA, 22203, US

(21) Appl. No.: 11/628,612

(22) PCT Filed: Jun. 7, 2005
(86) PCT No.: PCT/GB05/02232

§ 371 Date: Dec. 6, 2006

(30) Foreign Application Priority Data
Jun. 7, 2004 (GB) 041655.3

(51) Int. Cl. G06F 13/00

(52) U.S. Cl. 711/165

(57) ABSTRACT

A distributed storage network of computers is disclosed in which a determination as to whether to migrate a data item from a computer connected to said network to another computer is made in dependence on a policy document associated with that data item. Where the level of usage of the data item is less than an expected amount found in one or more fields of the policy document, the data item is migrated. This provides for system-managed storage which adapts to changes in the network.

The present invention relates to a distributed storage network.

Among the first organisations to encounter a problem in storing large amounts of data were US DOE National Laboratories such as the Los Alamos National Laboratory and the Lawrence Livermore National Laboratory: The solution adopted at the Los Alamos National Laboratory is described in a paper entitled “A Network File Storage System”, presented by W. Collins, M Devaney and E Willbanks at the fifth IEEE Symposium on Mass Storage Systems which took place in October 1982. The paper is to be found on pages 99-101 of the proceedings of that symposium.

The paper describes the Common File System which provided a control system and three types of storage. The first type of storage was online storage provided by an IBM 3350 Disk System which offered 6 GB of storage. The second type of storage was also online, but took longer to access—it was provided by an IBM 3850 Mass Storage System and offered 600 GB of storage. The third type of storage was offline—it was simply cabinets containing cartridges ejected from the IBM Mass Storage System. The control system was provided by an IBM 4341 computer connected to the IBM Mass Storage System and the IBM 3350 Disk System.

A file migration program running on the IBM 4341 computer migrated files from the disk system to the mass storage system if that file was infrequently accessed. The larger the file, the more rapidly it would be migrated to the mass storage system. A user could indicate whether they expected a file to be stored online or offline. The migration from the mass storage system to the cabinet (presumably a manual archiving operation) depended on this user-supplied indication. Such archiving took place if the file was not accessed for 360 days (if the file was small and labelled ‘online’), 120 days (if the file was large and labelled ‘online’), 45 days (if the file was small and labelled ‘offline’) or 15 days (if the file was small and labelled ‘online’).

The 1980's saw the rise of the personal computer. Instead of carrying out data processing on mainframes, data processing was increasingly carried out on relatively inexpensive personal computers connected to one another via a Local Area Network (LAN). LANs included facilities for file sharing and printer sharing. File sharing was provided by connecting a computer called a file server to the LAN. This is a well-known example of client-server computing.

When a file server is present on a LAN, a user generating a file using one of the PCs can choose (using a Graphical User Interface) whether to store the file on the hard disk of his PC or on non-volatile memory on the file server. Normally, the non-volatile memory of the file server is provided by a Redundant Array of Independent Disks which generates a number of fragments of the file, adding redundant information in the process, and stores the fragments on different disks. The redundancy means that access to one or more of the disks can fail without preventing users from retrieving files they have previously stored on the file server.

The 1990's saw many of the world's LANs interconnected to one another to form wide-area networks. The combined computing and storage power of personal computers interconnected via a wide-area network has led to an increased interest in peer-to-peer computing.

Hence, research into distributed storage systems comprising a plurality of interconnected personal computers, each having its own hard disk is now being undertaken—a peer-to-peer storage network is commercially attractive because the hardware required is already in use, and hence the expense of such a storage systems lies only in providing the software to run the system.

A Technical Report from the University of California, Santa Barbara entitled “Sorrento: A Self-Organizing Storage Cluster for Parallel Data-Intensive Applications”, by Hong Tang et al, discloses a distributed storage network which stores segments of a file at selected personal computers in a distributed storage network—the selection being dependent on the load on the processor in each computer and the load on the connection to the network from the computer. Subsequent migration of the segment is contemplated. Migration is triggered by one of the computers when it finds that it is significantly more loaded than the other computers in the network. The choice of which segments to migrate, and where to migrate them to, is made in dependence on the amount of time elapsed since the occasion on which the candidate segment for migration was last accessed. In particular, segments that have not been accessed for some time are moved to computers having a high network load, but with storage capacity to spare, whereas segments that have been recently accessed are moved to computers having a low network load, even if the storage space at that computer is limited.

The above report thus discloses a peer-to-peer distributed storage network which, like the mainframe network used at the Los Alamos National Laboratory in the early '80s migrates data from one storage medium to another in response to that data being infrequently accessed.

A problem arises in that the configuration of peer-to-peer networks is increasingly dynamic. In particular, the bandwidth and/or latency of a peer's connection to another peer in the network can vary over time. It will be seen that a choice of storage location made at the time a file is saved may cease to be valid later on owing to such a change in the configuration of the distributed system. The design of the Sorrento system mentioned above does not take into account the fact that a low level of usage of a file might not indicate that the content of that file is not popular, but instead indicate that the file is undesirably inaccessible to those computers which might wish to access the file.

According to a first aspect of the present invention, there is provided a distributed storage network comprising a plurality of interconnected computers, said computers being arranged in operation to store, for each of a plurality of data items, an indication of the level of usage expected of each said data item, each of said computers comprising a store arranged in operation to store one or more of said data items; and a processor arranged in operation to find the level of usage of each of said data items, and to move said data item to another of said computers on the level of usage found not being as great as indicated by said level of usage indication.

By storing an indication of the level of usage expected of a data item, and moving that data item from one computer to another in a distributed storage network when the level of usage falls below the expected level of usage, the distribution of data items within the storage network can change in reaction to a change in the configuration of the storage network. This is a more reliable method of data relocation of a data item than known methods since a measure of usage is used which is independent of the location of the data item within the distributed storage network.

In preferred embodiments of the present invention, said expected level of usage indication comprises an expected number of accesses within a predetermined time period. In comparison to other tests, for example a test to see whether the time expired since the file was last accessed is greater than a predetermined amount, these two parameters offer a measure of usage which can easily be adjusted to fit with different test frequencies, and which is also less likely to lead to anomalous results in the face of short-lived variations in the usage of a file.

According to a second aspect of the present invention, there is provided a method of operating a computer network to provide a distributed storage network, said computer network comprising a plurality of interconnected computers, said method comprising:
storing an indication of the expected level of usage of a file;
finding whether the actual level of usage of said file falls below said expected level of usage;
responsive to finding that the actual level of usage is less than expected in accordance with said stored indication, storing said file at a second computer in said computer network.

According to a third aspect of the present invention, there is provided a program storage device readable by each of the computers in a computer network, said device tangibly embodying a program of instructions executable by the computers to operate said network in accordance with the method of claim 10.

According to a fourth aspect of the present invention, there is provided a computer program product loadable into the internal memory of each of the digital computers in a computer network, said product comprising software code portions for operating said computer network in accordance with the method of claim 10 when said product is loaded onto each of the computers in said computer network.

In order that the present invention may be better understood, embodiments thereof will now be described, by way of example only, with reference to the accompanying drawings in which:

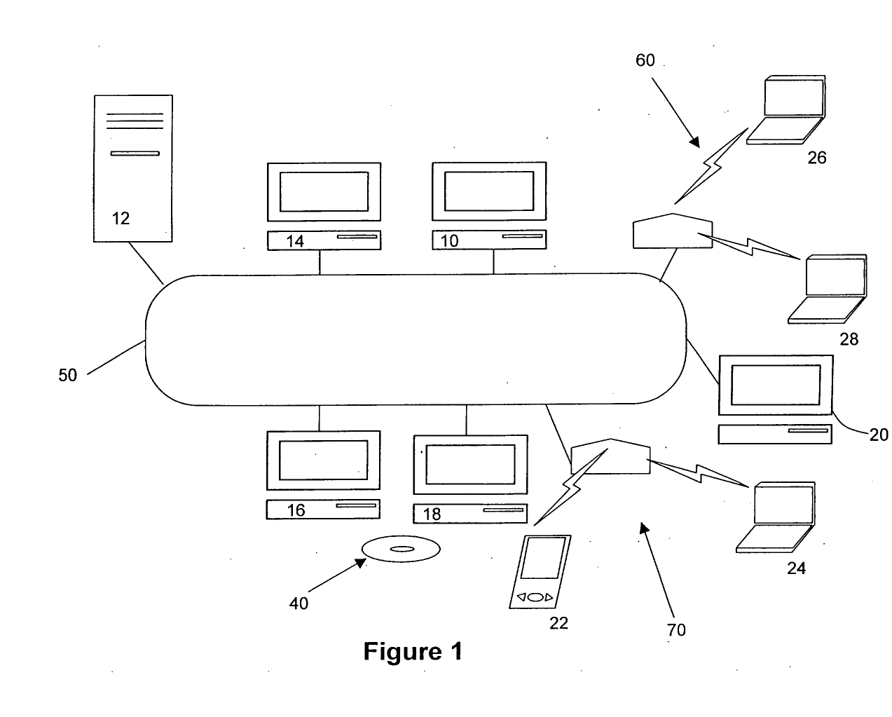

FIG. 1 is a schematic block diagram of a computer network according to the present invention;

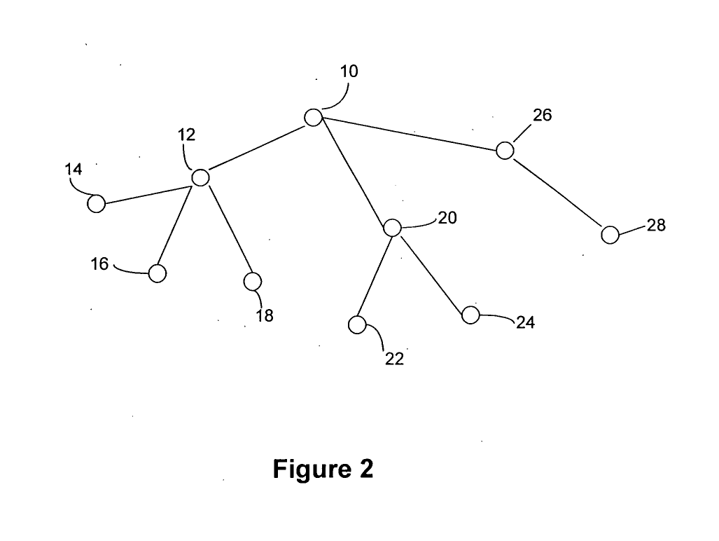

FIG. 2 is a diagram showing a logical network based on the physical network of FIG. 1;

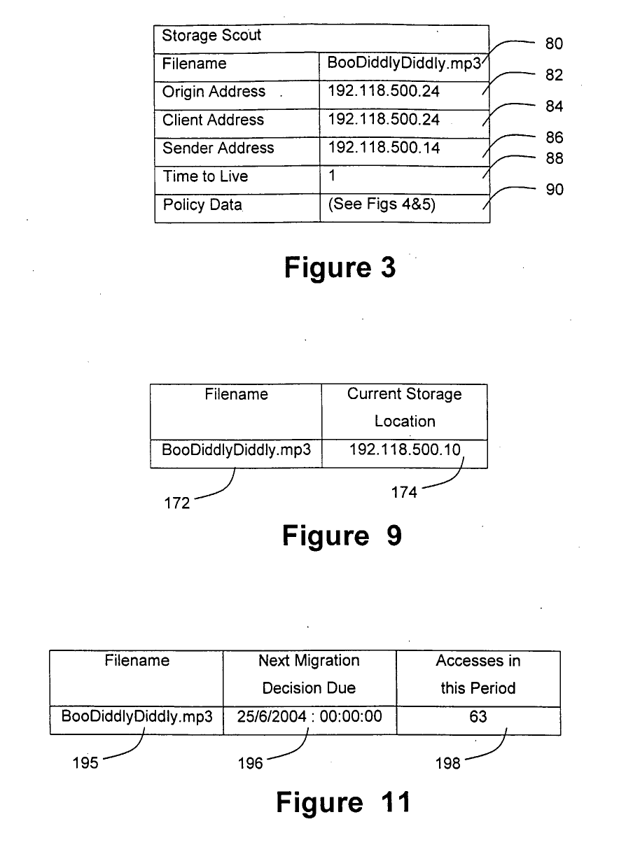

FIG. 3 is a table showing the contents of a storage message used to pass information between the nodes of the computer network of FIG. 1;

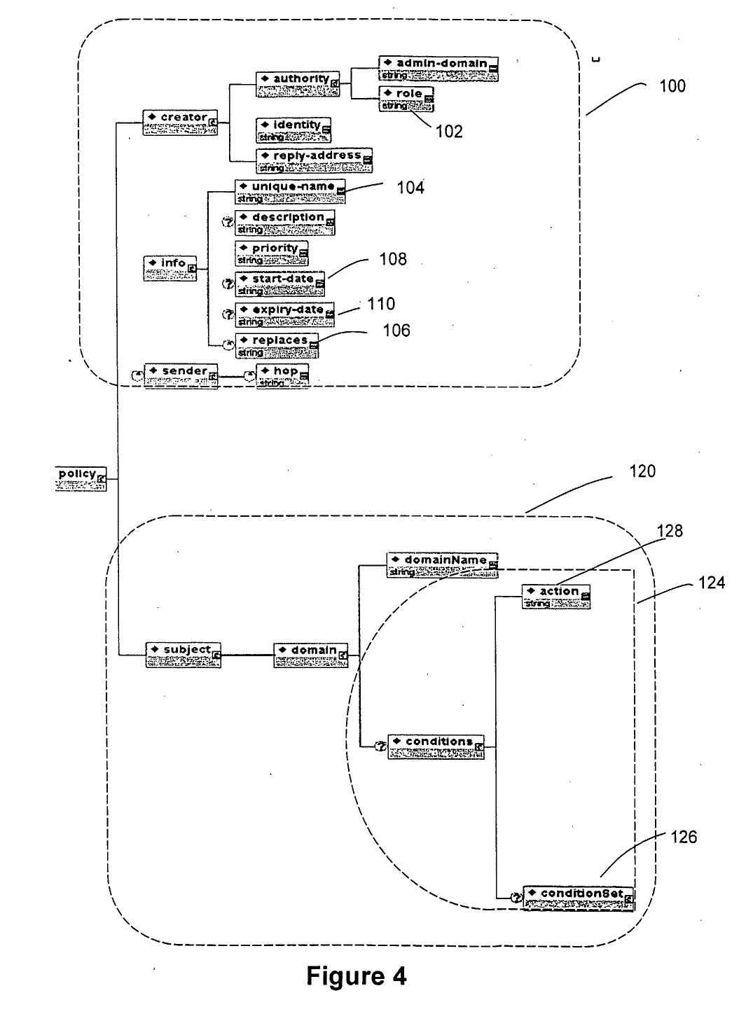

FIG. 4 shows a tree diagram representing a document type definition for a standard policy document;

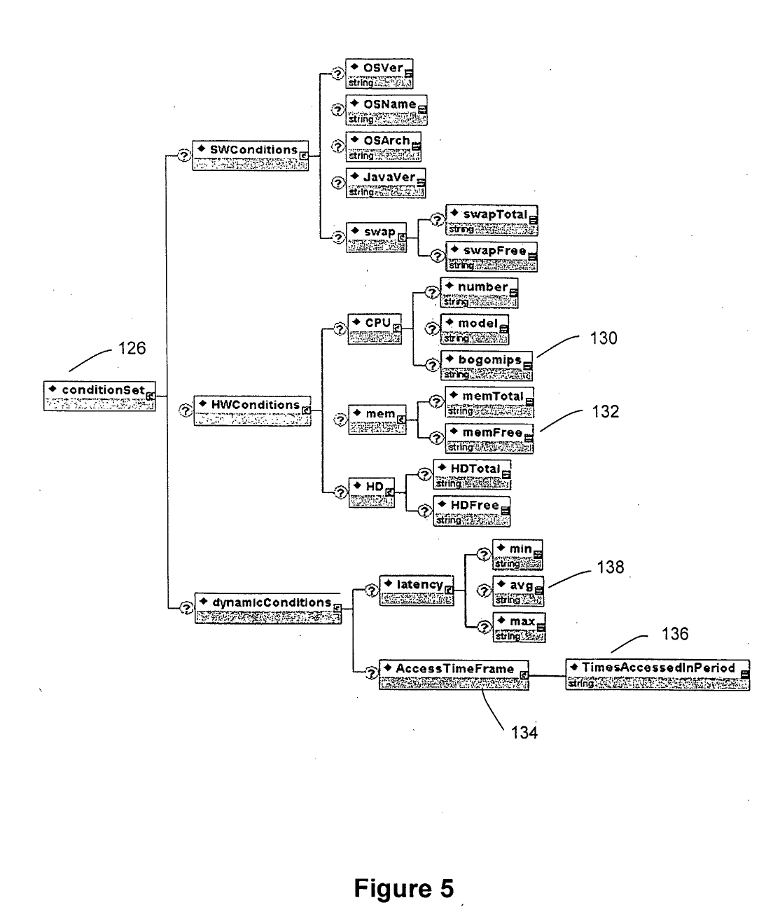

FIG. 5 shows an element of the document type definition in more detail;

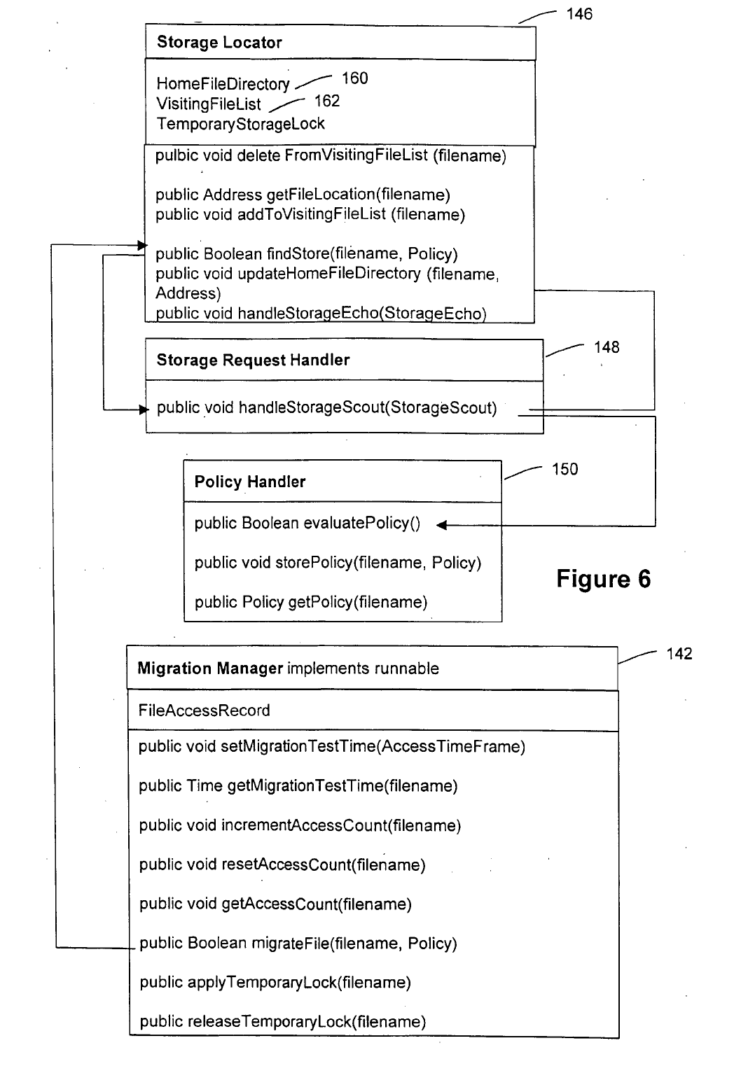

FIG. 6 is a class diagram illustrating the important classes and methods in the application program controlling the operation of the network of FIG. 1;

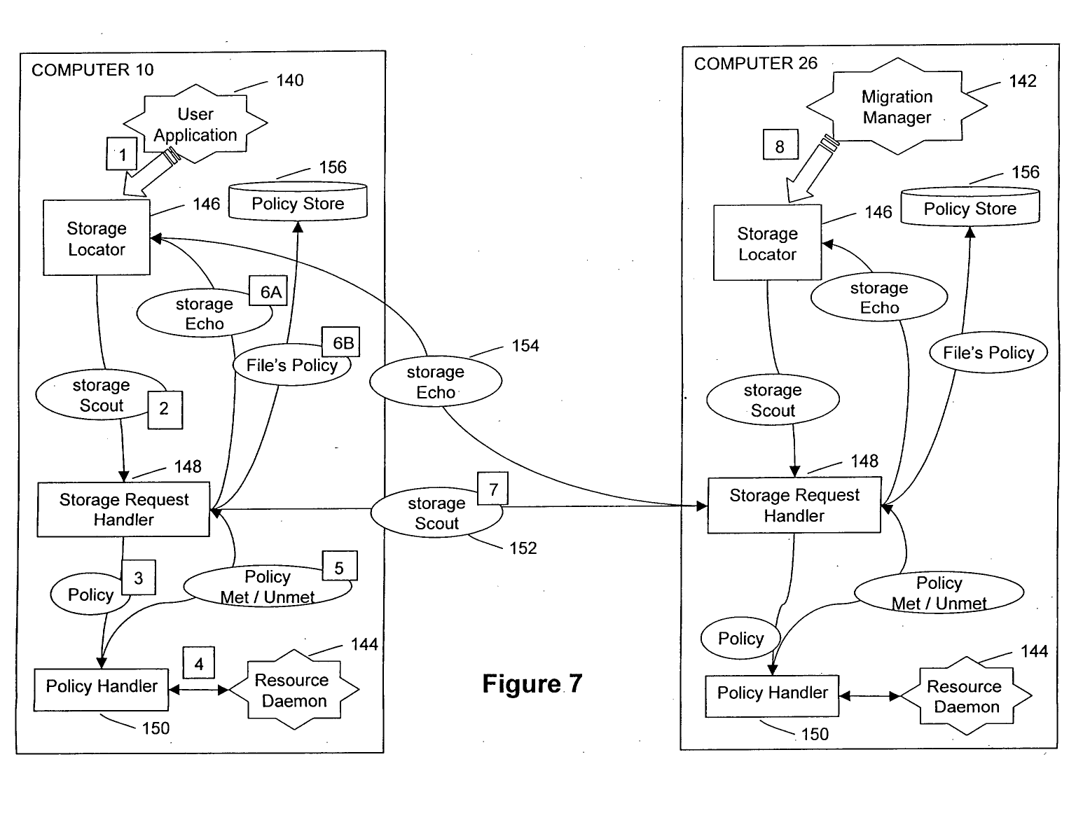

FIG. 7 is a schematic diagram of the overall operation of the computer network of FIG. 1;

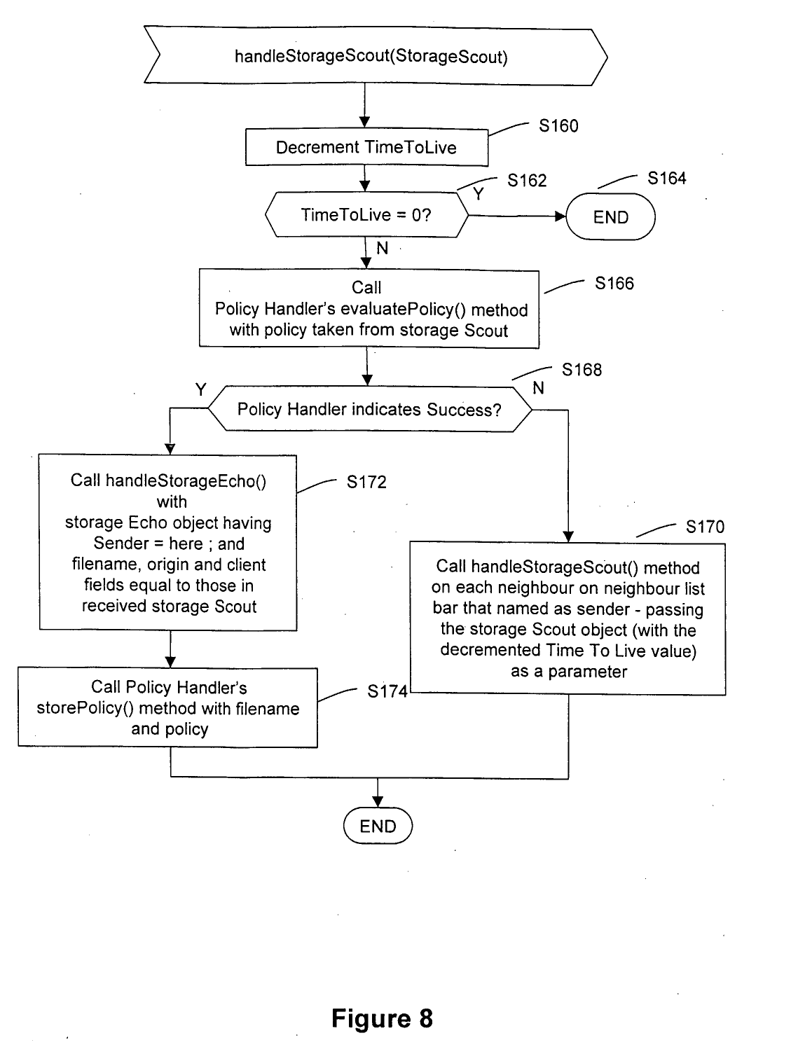

FIG. 8 is a flow-chart illustrating how each of the computers of the network of FIG. 1 reacts to the receipt of a storage scout;

FIG. 9 shows a file directory maintained by the computer which originally generated the file;

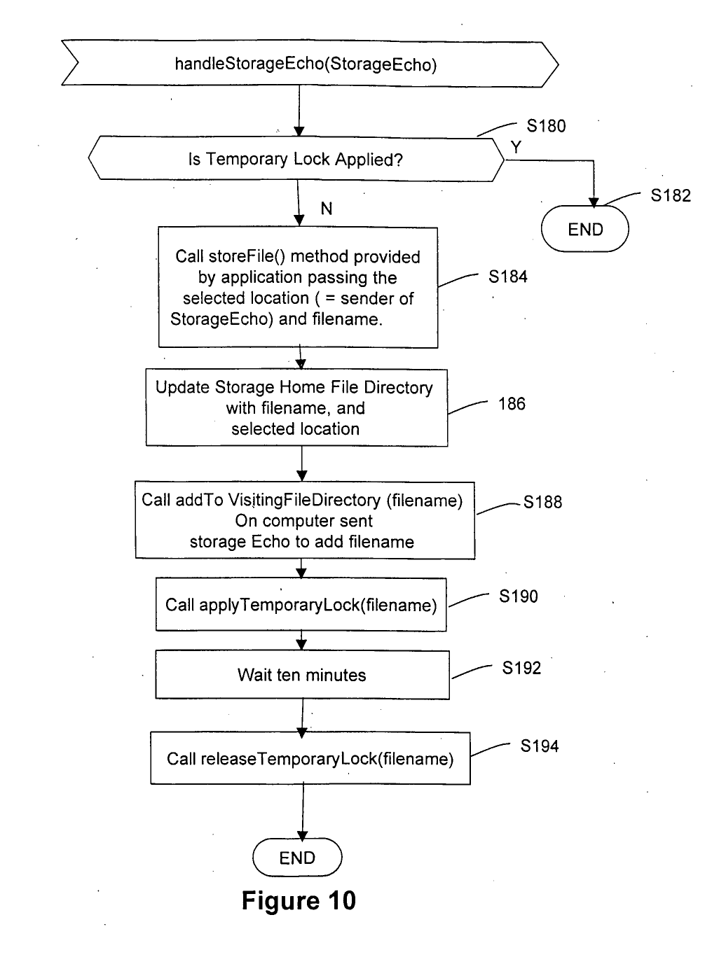

FIG. 10 is a flow-chart illustrating how each of the computers of the network reacts to the receipt of a storage echo;

FIG. 11 shows a table maintained by a migration daemon program executable to determine whether to migrate a file stored at one computer to another computer;

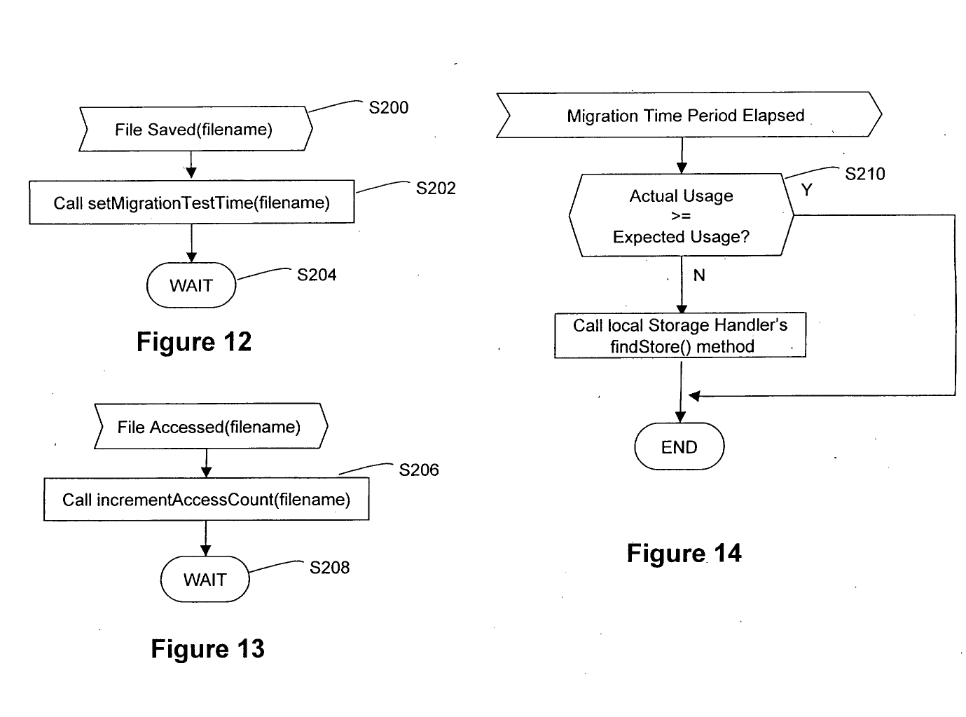

FIG. 12 is a flow-chart showing processing carried out by a computer storing a file in response to a request from a client computer;

FIG. 13 shows how the migration daemon program reacts to receiving a request to read a file stored in its memory;

FIG. 14 shows how the migration daemon program reacts to expiry of a file's migration period.

FIG. 1 illustrates an internetwork comprising a fixed Ethernet 802.3 local area network 50 which interconnects first 60 and second 70 Ethernet 802.11 wireless local area networks.

Attached to the fixed local area network 50 are a server computer 12, and five desktop PCs (10,14,16,18,20). The first wireless local area network 60 has a wireless connection to a first laptop computer 26 and second laptop computer 28, the second wireless local area network 14 has wireless connections to a third laptop computer 24 and a personal digital assistant 22.

Also illustrated is a CD-ROM 16 which carries software which can be loaded directly or indirectly onto each of the computing devices of FIG. 1 (12-28) and which will cause them to operate in accordance with a first embodiment of the present invention when run.

As is usual, each computer is provided with an operating system program. This operating system program will differ between different devices. For example, the operating system program on the personal digital assistant could be a relatively small operating system program such as Windows CE, whereas the operating system program running on the server 12 could be Linux, for example.

In the present embodiment, each of the computers is also provided with “virtual machine” software which executes the Java bytecode generated by a compiler of an application program written in the Java programming language. As its name suggests, such software converts a virtual machine language (that might be executed by a putative standard computer)—into the language of the actual machine on which the “virtual machine” software is installed. This has the advantage of enabling application programs in Java to be run on the different computers. Such software can be obtained from the Internet via http://java.sun.com for a number of different computing platforms. Those skilled in the art will understand that the classes offered as part of the Application Programmers Interface that comes as part of the Java programming language package will also be installed on each of the computers.

Each computer also has networking software installed upon it enabling each of them to establish communications links with each other. In the present embodiment, communication is carried out using the TCP/IP protocol suite.

In addition to the data maintained as part of the TCP/IP communication software, each of the computers maintains a neighbour list listing those computers which are its neighbours in an overlay network. An example of an overlay network based on the physical network of FIG. 1 is shown in FIG. 2. It will be seen that neighbour lists of the computers are set up in such a way as to give the overlay network the form of a spanning tree rooted at the computer 10. In alternative embodiments, the overlay network is formed using a policy based mechanism such as that described in co-pending international patent application WO 04/001598. In other embodiments, the method described in co-pending. international patent application WO 04/047403 is used.

In addition to this, the CD-ROM 16 contains a peer-to-peer application program and other programmer-defined classes written in the Java programming language. Each of the classes and the peer-to-peer application program is installed and run on each of the computers (10-28).

Using the Remote Method Invocation software provided as part of the Java language package, the computers (12-28) communicate with one another by passing storage messages between them. The StorageMessage class defines an object which includes the following variables, and so-called “getter” methods for providing those variables to other objects:

i) a filename;

ii) an origin address—this is the address of the computer that originally requested storage of the file;

iii) a client address—this is the address of the last computer to initiate storage or re-storage of the file;

iv) a sender address—this is the address of the computer which sent the Storage Message.

Storage Messages are divided into two types, Storage Scouts (an example is shown in FIG. 3) and Storage Echoes. These classes inherit data members i) to iv) (80, 82, 84 and 86 respectively) above.

A Storage Scout object is shown in FIG. 3. It will be seen that it additionally has:

v) a time-to-live value 88—this limits the number of hops between computers that the Storage Message can travel before ceasing to exist.

vi) policy data 90—this is a policy document which will be explained in detail below with reference to FIGS. 4 and 5.

FIG. 4 shows, in tree diagram form, a Document Type Definition (DTD) which indicates a predetermined logical structure for a ‘policy’ document written in extensible Mark-Up Language (XML). One purpose of a ‘policy’ document in this embodiment is to set out the conditions which an applicant computing device must fulfill prior to a specified action being carried out in respect of that computing device. In the present case, the action concerned is the storage of a file at a computing device in a distributed computing network.

As dictated by the DTD, a profile document consists of two sections, each of which has a complex logical structure.

The first section 100 refers to the creator of the policy and includes fields which indicate the level of authority enjoyed by the creator of the policy 102 (some computing devices may be programmed to ignore policies generated by a creator who has a level of authority below a predetermined level), the unique name 104 of the policy, the name of any policy it is to replace 106, times at which the policy is to be applied (108, 110) etc.

The second section 120 refers to the individual computing devices or classes of computing devices to which the policy is applicable, and sets out the applicable policy 124 (& FIG. 5) for each of those individual computing devices or classes of computing devices.

Each policy comprises a set of ‘conditions’ 126 and an action 128 which is to be carried out if all those ‘conditions’ are met. The conditions (FIG. 5) are in fact values of various fields, e.g. processing power 130 (represented here as ‘BogoMIPS’—a term used in Linux operating systems to mean Bogus Machine Instructions Per Second) and free memory 132.

An example of the set of ‘conditions’ 126 which might be used in the present embodiment is shown in FIG. 5. Importantly, the ‘conditions’ include an AccessTimeFrame 134 (which is a period defined in hours) and a TimesAccessedinPeriod which is an integer value representing the number of times that the originator of the file would expect the file to be read within the AccessTimeFrame. Also included within the set of dynamic conditions is an average latency value 138.

The programmer-defined classes provided on the CD-ROM 40 include a user application program 140, a data migration daemon class 142 (that runs as a low-priority thread), a resource daemon 144 (which also runs as a thread), a Storage Locator 146, a Storage Request Handler 148, a policy handler 150 and the Storage Message, Storage Scout 152 and Storage Echo 154 classes discussed above. Also provided on the CD-ROM 40 is database software which provides policy store 156. All these classes and software are installed on each of the computers in the network of FIG. 1.

FIG. 6 shows the important methods provided as part of Storage Locator 146, Storage Request Handler 148 and Policy Handler 150, and Migration Manager 142 classes and the calls to those methods made by objects instantiated from those classes.

Each Storage Locator object 146 provides a findStore( ) method that takes a filename and a policy as parameters, calls the local Storage Request Handler's handleStorageScout( ) method (and thereby attempts to store the file in the distributed storage network), returning a Boolean value indicating whether the attempt to store the file is successful or not.

The Storage Locator object 146 also provides a handleStorageEcho( ) method which takes a Storage Echo object as a parameter and ensures that a directory maintained at the computer which originated the file, (which directory keeps track of where files originating from that computer are stored) is updated.

This Home File Directory object 160 is a list of filenames originally generated at this computer and the address at which the file of that name is currently stored (FIG. 9). The Storage Locator class 146 provides ‘Get’ and ‘Set’ methods for making and querying entries included within the Home File Directory 160. Similarly, the Storage Locator 146 maintains a Visiting File List 162 listing the files generated by other computers which it currently stores. This takes the same form as the Home File Directory 160.

The Storage Request Handler 148 has a handleStorageScout( ) method which takes a Storage Scout object as a parameter, calls the local Policy Handler's 150 evaluatepolicy( ) method in order to find, in the light of the policy FIGS. 4 and 5 included within the StorageScout, (FIG. 3) whether the computer on which it resides is suitable for storing the file and calls the handleStorageEcho( ) method of the Storage Locator 146 on the client computer if it finds that the computer is suitable for storing the file.

The Policy Handler object 150 provides an evaluatePolicy( ) method which will find whether the local computer meets the conditions specified in the policy (FIGS. 4 and 5) passed to it, and return a Boolean result. It also provides a storePolicy( ) method which stores a policy and a filename to which the policy applies (both things being passed as parameters) in the Policy Store 156. In addition to that a method enabling the policy (FIGS. 4 and 5) associated with a given filename to be retrieved is provided.

The Policy Handler class 150 includes an XML parser (such as the Xerxes parser) which takes the policy supplied by the agent and converts it into a Document Object Model—this gives the Policy Handler class 150 access to the values of the fields of the policy document (FIGS. 4 and 5). The Policy Handler 150 interprets the condition (FIG. 5) part of the policy and then evaluates the condition.

To do this for a hardware or software condition, it triggers a resource daemon program 144 present on the computer to run. The resource daemon program 144 can return the current value of a parameter requested by the Policy Handler class 150. The Policy Handler 150 then replaces the parameter name in the condition with the value received from the resource daemon 144.

Finally, the Migration Manager object 142 maintains a File Access Record (FIG. 12) and methods for setting the two fields of a File Access Record associated with each filename—namely a time when the next migration test should be carried out and a count of the number of times the file has been accessed within the current migration test period. The methods for updating the access count include an increment method and a reset method (which resets the count to zero).

The operation of the present embodiment will now be described with reference to FIGS. 7 to 14. FIG. 7 shows the overall operation and FIGS. 8 to 14 show some of the methods employed in more detail.

By way of example of the operation of all the components of FIG. 1, FIG. 7 shows the operation of computers 10 and 26 in response to the user of computer 10 requesting storage of a file within the distributed storage system provided by the computer network of FIG. 1 in accordance with the first embodiment.

On a user requesting the storage of a file, the user application program 140 running a PC 10 calls the local Storage Locator 146 object's findStore( ) method, passing it the filename and a policy (FIG. 5) to be applied when selecting a location for storing the file. If the user or application does not specify a policy, then a default policy may be applied. The findStoreo method calls the local Storage Request Handler's 148 handleStorageScout( ) method passing it a Storage Scout object (FIG. 3) containing the filename and policy (FIGS. 4 and 5) received from the application program, but setting each of the origin, client and sender addresses as the local computer's address. In this example, computer 10 intitiates the storage operation (and this is the client in this example). It is to be understood that all the computers can operate in this way—i.e. any of the computers (10-28) could function as a client.

The operation of the handleStorageScout( ) method is shown in more detail in FIG. 8. The method begins by reducing S160 the Time To Live field in the StorageScout by one. If that reduces the Time To Live value (FIG. 3: 88) to zero then the method ends S164. If it does not, the Policy Handler's 150 evaluatePolicy( ) method is called S166 to find S168 whether the present computer meets the requirements set out in the policy (FIGS. 4 and 5) for storing the file. If those conditions are not met then the handleStorageScout( ) method on each of the computers in this computer's neighbour list (computers 12, 20 and 6 in this example—see FIG. 2) is called passing the StorageScout as a parameter (with the decremented Time to Live value). Those skilled in the art will realise that this uses the Remote Method Invocation facilities provide by the Java Programming Language Software. If one of those computers finds S170 that (steps S160-S168 are run on the neighbour computer (12, 20, 26) in reaction to the call) the conditions for file storage are met then the origin computer's 10 handleStorageEcho( ) method is called S172 setting the sender field of the Storage Echo to the address of the current computer (12, 20, 26), but keeping the other fields the same as those found in the received Storage Scout. In addition, the filename and its associated policy are stored S174 in the Policy Store 156 on the neighbouring computer (12,20, 26).

As can be seen from the above description, Storage Scouts will proliferate outwardly from the client computer 10 when the user application attempts to save a file until either they have travelled the number of hops specified in the Time to Live field (FIG. 3: 88) of the original Storage Scout or a suitable location has been found and they have returned as a Storage Echo.

FIG. 9 illustrates an entry in the Home File Directory maintained by each computer (10-28). For every file generated by this computer and saved using the distributed storage network software, a record is entered into the directory giving the filename of the saved file 172 and the address of its location 174.

FIG. 10 shows the handleStorageEcho( ) method in more detail. In order to deal with the possibility of many Storage Echoes returning, the method begins by checking S180 whether the temporary lock value is set to a ‘locked’ value—if the temporary lock is applied, then the method ends S182. If the temporary lock is not applied then it can be assumed that this is the first Storage Echo sent and the method continues. The relevant method in the application is then called S184 to save the file on the hard disk of the sender (12, 20, 26) of the Storage Echo. Once that has been done an entry is made S186 in the Home File Directory object (FIG. 9) maintained by the Storage Locator on the client computer 10 giving the filename and the address of the sender (12,20,26) of the Storage Echo. In addition the addToVisitingFileList( ) method on the sender computer (12, 20, 26) is called S188 in order to add the saved file to the list of files stored on that computer. Thereafter, the temporary lock variable is set to a ‘locked’ value S190. After waiting for a predetermined amount of time S192 (say 10 minutes) the temporary lock variable is reset to an ‘unlocked’ value S194.

It will be seen how the procedures described above enable a file to be placed at a suitable storage location when it is saved. In order to take account of the network changing, the MigrationManager 142 on each computer (10-28) occasionally calls the findStore( ) method of the local Storage Locator 146 in relation to each of the files listed in the local Visiting File List. The operation of the Migration Manager 142 in determining when to generate such a call will now be described with reference to FIGS. 11 to 14. As an example of a network change, consider that the initial placement of a file from computer 10 is onto laptop PC 26. The AccessTime Period is set in the file's policy to 100 hours, and the number of accesses to 50. Although the wireless link from the laptop computer was operating at 11 Mbps⁻¹ at the time the file was saved, the connection now operates at only 1 Mbps⁻¹.

FIG. 11 shows an entry in the File Access Record maintained by the Migration Manager 142 on each of the computers (10-28). An entry is present for each of the files listed in the Visiting File List. Each entry has a filename 195, the time 196 that the next migration decision is due for that file, and the number of accesses 198 since the last migration.

The Migration Manager 142 is implemented as a low priority thread which runs on the following events occurring:

a) the saving of a file on the hard disk of the local computer;

b) the accessing of a file on the hard disk of the computer; and

c) the expiry of a migration time period found in the File Access Record (FIG. 12) associated with a file in the Visiting File List.

As shown in FIG. 12, on a file being saved on the local computer's hard disk S200 the Migration Manager 142 calculates S202 the time of the next migration test by adding the AccessTimePeriod (FIG. 5:134) in the file's policy (stored in the policy store) to the current time. The result 196 of that calculation is recorded in the File Access Record (FIG. 12) maintained by the Migration Manager 142. The Migration Manager 142 thread then enters S204 a wait state ready to be re-activated by one of the three events mentioned above.

As shown in FIG. 13, on a file on the computer's hard disk being accessed, the Migration Manager 142 calls S206 its incrementAccessCount( ) method in order to increment the number of accesses 198 of the file in the current migration time period by one S206. Once this has been done, the thread then enters a wait state ready to be re-activated by one of the three events mentioned above.

As shown in FIG. 14, on the migration time period associated with a particular file elapsing, the Migration Manager reads the number of accesses from the File Access Record, and compares S210 that value 198 to the expected number of accesses (FIG. 5:136) found in the policy associated with the file. In the event that the number of accesses is lower than expected, the local Storage Locator's 146 findStore( ) method is called passing the filename and policy as parameters. Hence, If the characteristics of this computer have changed (e.g. if its average latency has increased owing to its link to the network becoming slower) then this will result in the file being saved at a different location in the network.

So, in the above example, if computer 26 fails the tests set out in the files policy at the time of the migration test, then the file will be moved to another computer (14 say).

Thus, it will be seen how the above embodiment will, over the course of time, move files until they reach a location where they are accessed as often as the user might expect.

In particularly advantageous embodiments of the present invention, a peer-to-peer network for storing read-only files is provided. Such a network is suitable for storing files such a music tracks which are not, by and large, edited by programs which open those files. The constant nature of those files allows a straightforward scheme for identifying those files to be used—a value calculated from the data making up the file can be used as a unique ID. Examples of such values include hash-codes and CRC values calculated from the data making up the file. It is anticipated that a plurality of copies of the file might be stored on respective computers in the network.

In such embodiments, the file server (FIG. 1; 12) can act as a nameserver—it can provide the unique file ID to any computer which provides it with a more user-friendly file identifier.

On a user wishing to retrieve the file, the application on the user's computer is arranged to send the user-friendly filename as given by the user to the nameserver in order to obtain the corresponding unique file ID. The user's computer can then send out File Scouts which proliferate much like the Storage Scouts discussed in the above embodiment to file a computer which stores the file. Once the file is found, a File Echo (like a Storage Echo as discussed above) informs the requesting computer where a copy of the file is to be found. The requesting computer can then download the file from the computer identified as storing a copy of the file. On such a download occurring, the number of accesses to the copy of that file stored on that machine is updated.

The migration of the file then works as in the above-described embodiment. In this embodiment, it will be seen how copies of the file which find themselves in locations from which the file is not downloaded will be migrated away from that location and will continue migrating until they are in a location at which they are accessed sufficiently frequently.

Variations that might be made to the above embodiments include:

i) In the above-described embodiments, each computer was provided with software that both requested storage and offered storage (a peer-to-peer system). Embodiments are also possible where one or more computers has only the software necessary to request storage or only the software necessary to offer storage (i.e. a client-server element is present in the system).

ii) In an alternative embodiment, the findStore( ) method calls the handleStorageScout( ) method of the Storage Request Handlers of the neighbour computers and not the Storage Request Handler of the local computer. This encourages more migration of files and hence provides a more adaptive arrangement than the embodiment described above.

iii) each computer in the above embodiments stored copies of entire files. In alternative embodiments, the files may be split into segments and distributed over several computers. In preferred cases, erasure codes are used. Such erasure codes allow the file to be broken up into n blocks and encoded into kn fragments where k>1. The file can then be re-assembled from k fragments. This offers a considerable advantage in a network of transient peers, since only k of the selected peers need to be available to allow file retrieval and no specific sub-groups need to be intact. Through the user's preference, the parameters of n and k are modified to achieve the appropriate degree of redundancy and reliability. An example of the type of erasure code that can be used is the Vandermonde FEC algorithm. In this case, it is one or more fragments of the file that will be migrated, rather than the entire file. It is found that using fragmentation allows more reliable storage than simple mirroring for a given amount of stored data representing the contents of a file.

1. A distributed storage network comprising a plurality of interconnected computers, said computers being arranged in operation to store, for each of a plurality of data items, an indication of the level of usage expected of each said data item, each of said computers comprising:
a store arranged in operation to store one or more of said data items; and
a processor arranged in operation to find the level of usage of each of said data items, and to move said data item to another of said computers on the level of usage found not being as great as indicated by said level of usage indication.

2. A distributed storage network according to claim 1 in which said indications of expected level of usage are distributed around said computers.

3. A distributed storage network according to claim 2 in which said indications of expected level of usage are stored on the same computer as the data item to which they refer.

4. A distributed storage network according to claim 1 in which said computers are further arranged in operation to store one or data placement rules for a data item at the same computer as said expected level of usage for said data item.

5. A distributed storage network according to claim 1 in which said expected level of usage indication comprises an expected number of accesses within a predetermined time period.

6. A distributed storage network according to claim 5 in which said expected level of usage indication comprises a time period indication and an expected number of accesses within the time period indicated by said time period indication.

7. A distributed storage network according to claim 1 in which each of said computers stores said condition interpreter code.

8. A distributed storage network according to claim 1 wherein each of said computers stores a database providing persistent storage of said expected level of usage indication.

9. A distributed storage network according to claim 1 in which said interconnected computers include computers having differing hardware architectures and operating system programs stored thereon, each of said computers further storing common machine emulation code executable to translate code executable on said common machine to code executable on the hardware architecture and operating system of the machine on which the emulation code is executed.

10. A distributed storage network according to claim 1 wherein at least one of said computers is a personal computer.

11. A distributed storage network according to claim 1 wherein said computers comprise a plurality of personal computer.

12. A distributed storage network according to claim 1 wherein said distributed storage network is arranged in operation to operate as a peer-to-peer network.

13. A method of operating a computer network to provide a distributed storage network, said computer network comprising a plurality of interconnected computers, said method comprising:
storing an indication of the expected level of usage of a file;
finding whether the actual level of usage of said file falls below said expected level of usage;
responsive to finding that the actual level of usage is less than expected in accordance with said stored indication, storing said file at a second computer in said computer network.

14. A program storage device readable by each of the computers in a computer network, said device tangibly embodying a program of instructions executable by the computers to operate said network in accordance with the method of claim 13.

15. A computer program product loadable into the internal memory of each of the digital computers in a computer network, said product comprising software code portions for operating said computer network in accordance with the method of claim 13 when said product is loaded onto each of the computers in said computer network.
